(19) United States
(12) Patent Application Publication
(10) Pub. No.: US 2008/0282095 A1
(43) Pub. Date: Nov. 13, 2008

(54) METHOD FOR TRANSFERRING AND/OR PROVIDING PERSONAL ELECTRONIC DATA OF A DATA OWNER

(76) Inventors: Sultan Haider, Erlangen (DE); Georg Heidenreich, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 12/116,387

(22) Filed: May 7, 2008

(30) Foreign Application Priority Data
May 7, 2007 (DE) 10 2007 021 275.7

(51) Int. Cl. G06F 12/14; G06Q 20/00; H04L 9/32

(52) U.S. Cl. 713/193; 705/76

(57) ABSTRACT

In a method to transfer and/or to provide personal electronic data of an owner, in particular health-related electronic data of a patient, the personal electronic data are transferred and/or provided in a form stored on a data medium, at least partially encrypted, together with at least one decryptor for at least partial decryption, as well as at least one mechanism to present and/or to access and/or to enable the presentation of and/or the access to at least one part of the personal electronic data.

### BACKGROUND OF THE INVENTION

1. Field of the Invention

The invention concerns a method for transfer and/or for provision of personal electronic data of an owner of the data, in particular health-related electronic data of a patient, as well as a data medium and an associated facility.

2. Description of the Prior Art

Particularly in the case of health-related electronic data, data often is present in a large volume since the data are, for example, larger image files. Nevertheless, such data must often be relayed to subsequent treatment locations, for example to a physician in private practice, to a clinic, or to a rehabilitation facility. The data networks currently available do not exhibit the necessary capacity for the transfer of such data sets. The increase of the bandwidth of available data networks is only of limited benefit in this regard since such increasing bandwidth competes against an ever growing volume of modern diagnostic data such as, for example, image data.

Therefore, numerous attempts have been made to give a patient electronic health data on a storage medium, for example a data medium in the form of a compact disc (CD), a digital versatile disc (DVD) and a memory card, and the patient provides this storage medium later to the apparatuses of a further medical facility of the patient's choice as a destination of the data. The use of such a storage medium is not always possible, however, because the data format that is used on the medium is often incompatible with the data formats that can be processed at the destination. Since a number of available possibilities exist for data format in the health field, and since the technical progress develops rapidly, data circulate in many different formats, such that the probability that the formats generated by an author are “understood” at the site of the readout is very low.

Security considerations additionally exist with regard to protection of the privacy of the patient (for example guaranteeing the authenticity at the reading locations) since under the circumstances serious medical procedures can depend on the personal data, for example.

### SUMMARY OF THE INVENTION

An object of the invention is to provide a method that is improved with regard to the aforementioned consideration.

This object is achieved in accordance with the invention by a method of the aforementioned type wherein the personal electronic data that are transferred and/or are stored at least partially encrypted on a data medium together with at least one decryptor for at least partial decryption of the encrypted data as well as at least one interface for presentation of and/or for access to and/or to enable the presentation of and/or the access to at least one part of the personal electronic data.

According to the inventive method, for example, suitable software is provided as an interface for a display of or access directly to the medium that also serves as a data medium for the health-related data. This enables execution of this software at the destination for viewing or processing of the data given to the patient to take with him or her, without having to make special assumptions about the apparatuses at the destination.

Furthermore, an encryption is provided to protect the privacy of the patient or another owner of the personal electronic data as well as possibly to ensure the authenticity of the data. Accordingly the data, insofar as they concern sensitive contents, are stored encrypted on the data medium, and in fact together with the decryptor or at least a portion of the decryptor and the software or another means for presenting the data for the owner or a health professional or a further person, or for access by other apparatuses.

It is thereby possible to safely forward extensive data sets (in particular in the health field) without problems arising due to the specialized and manifold formats that are often used not only in this field. For data transfer the data medium is normally carried by the data owner, for instance during a visit to a physician or a clinic, such that the data are flexibly available at any time. The decryptor is appropriately fashioned such that a final decryption of the data is possible only in connection with further information (for example a key) that is stored separately. The decryptor is in a form on the data medium itself so that, for example, only a decryption mechanism is stored, with the actual decryption being possible only together with further auxiliary information such as, for example, a password or information on an additional data medium or the like.

The data thus can be presented at the destination in a specific form, for example on a screen. Furthermore, access (active or passive) to the data is possible. For example, access can be designed to occur differently dependent on the destination or dependent on the specifications of the data owner, such that a read access, a write access or a general processing access to change the data are possible.

According to the invention, one or more interfaces to present and/or to access and/or to enable the presentation and/or the access can be used that include at least one program. Software (which can be a simple reader program or a complex software package with various presentation possibilities or editing possibilities for the data) can thus be supplied as well on the data medium. For example, image processing software can be supplied as well on the data medium, this image processing software enabling magnetic resonance exposures or other image exposures of the patient to be prepared for an optimal viewing or extraction of the relevant information.

At least one decryptor for at least partial decryption in secured form is appropriately stored on the data medium. This precludes unauthorized persons who merely come into possession of the data medium from accessing possibly sensitive data that are stored on the medium. For example, it is possible that the decryption means are stored on the data medium such that an additional key that is not located on the data medium is required for reading or for processing or overwriting the data. The decryptor can be stored in a secured form on the data medium since further information (which, for example, is secured via a password or must be retrieved from an external server or the like) is necessary for the ultimate decryption, for example only for reading or processing the data.

The personal electronic data can be stored in specialized formats on the data medium. For health-related electronic data, a number of specialized formats exist, for example with regard to the specifications according to the Digital Imaging and Communications in Medicine standard (DICOM standard). In the inventive method in which the presentation or access mechanism (that can include a processing mechanism) are directly supplied as well on the data medium, such specialized data formats can be relayed without problems. A general practitioner who normally does not possess the comprehensive software that are available in a special clinic thus can also access such data for reading or for processing thereof. Assumptions about a specific software at the destination (for example the practice of a general practitioner are not necessary.

A passive data medium can be used for the inventive method. This offers the advantage that larger data sets can also be relayed with the inventive method in a relatively cost-effective manner. A specific technical embodiment of the data medium beyond the storage possibilities is not required.

At least one mechanism to present and/or enable the presentation for the owner and/or an authorized party (in particular a health professional) and/or at least one mechanism to access and/or to enable the access via at least one apparatus can be stored on the data medium. For example, software to present the data for the owner or possibly slightly varied software to present the data for the health professional can be located on the data medium. These presentation mechanisms can differ, for example, in that, dependent on specific authorizations the owner or a health professional may view different or more or fewer data than another person who likewise has access. This requires a design of the access so as to be specific for different users.

Information to enable the presentation can require software or another means that is stored on the data medium to be initially installed on a computer at a destination, or must be started from the data medium, in order to allow the data to be presented that are associated with this information. This can be accomplished, for example, by a data file being loaded into the software.

Further information can be in the form of a mechanism that enables an automatic or semi-automatic access (possibly ensuing after an operator confirmation) to an apparatus such as, for example, a computer or a reader. Such an access apparatus can possibly be a medical device, for example an image data acquisition device such as a computed tomography device or the like that, for example, automatically imports, from the data medium, the patient data that are required, for example, for an adjustment of image acquisition parameters.

A data medium available to the owner of the personal electronic data is advantageously used. In the medical field this offers the advantage that a patient who has been referred to a further location for treatment or for data acquisition can carry the relevant data with him or her in the form of the data medium, and can keep track of such critical data. In this case the relaying or transfer of the data ensues via the transport of the data medium by the owner.

In addition to the at least one decryptor for at least partial decryption, further information (in particular a key) that is not stored on the data medium can be required for a complete decryption. This has the advantage that at least one part of the data (that was possibly classified as particularly worthy of protection) cannot yet be presented or even modified solely by the possession of the data medium as a transfer medium; rather, further information for decryption is necessary for a presentation or for an access. This further information or decryptor is stored differently, to preclude a person who comes into possession of the data medium without authorization from reading or even modifying the data stored thereon that are particularly worthy of protection.

The further information can be at least one secret key that is exclusively available to the owner of the data; and/or at least one private key that the owner of the data and/or a representative of the owner stores on an additional data medium before the generation of the data medium; and/or a one-time key that is provided to a representative by a secure third party (in particular by sending, possibly after an assignment and/or with technical authorization of the owner of the data) after generation of the data medium. A number of such keys for the data medium can be present, or only a single key can be used.

Under the circumstances, a secret key that is known exclusively to the patient is thus used for decryption. The use of a private key for data decryption is likewise conceivable, with this private key being held by the patient, for example on a separate storage medium. Furthermore, a private key that is present at a representative (such as a specific health professional who the patient has designated before the generation of his medium) can serve for complete decryption in connection with the decryption mechanisms on the data medium. For example, the patient can determine in advance that his or her family physician should receive a private key for data decryption.

Additionally or alternatively, the use of a one-time key that can be sent to a representative (such as a health professional or a clinic or the like) by a secure third party after generation of the data medium is conceivable (for example only for specific data on the data medium), if applicable by request and possibly with technical authorization by the patient. Such a third party can be a party that, for example, offers electronic security services specifically for physicians or specific physicians or is associated with a clinic association or the like.

The decryption of the personal electronic data can be conducted entirely locally at the location of the data medium (in particular via at least one secret and/or private key) and/or under access to a data network (in particular to obtain a one-time key). For example, a local decryption of the data is possible without access to a data network when the patient or the data holder keeps a private key on a separate medium and carries this with him or her. The same applies in the use of a secret key that only the data owner knows and which he or she can specify to enable the complete decryption (for example at his or her family doctor), for example in the form of an input of the key via a keyboard of a computer or the like. Also, no data network access is required for a private key that is provided to a representative (such as a family doctor or a special clinic).

Alternatively, for example, a one-time key is retrieved by access to the Internet or an additional data network. This key the serves for decryption of at least one part of the data stored on the data medium of the patient. The one-time key can specifically be fashioned such that only specific data (for example data of a designated image acquisition or image acquisition sequence) can be decrypted with it.

The personal electronic data can be in a form that requires authentication by at least one signature, in particular to verify the integrity of at least one means to present and/or to access and/or to enable the presentation and/or the access. The verification of the contents and the authentication of the author designation can be enabled with such a signature element. For example, only by this signature is it possible for a reading health professional to be able to trust the validity of the data or of the author of the data. A basic assumption is made so that, for example, duplicate examinations can be avoided or the data can influence the determination of further examinations or the treatment of the patient via a mobile health software on a data medium according to the inventive method. In safety-critical fields in which personal data are fundamental, such a validity check is often indispensable.

Moreover, at least one mechanism for presentation and/or for access and/or to enable the data compilation and/or the access to at least one part of the person of the personal electronic data can be made authenticable via at least one signature. This also enables the integrity of a software or the like to be technically verified. For example, this can be meaningful in order to prevent the introduction of “computer viruses” or the like. The acceptance of the data medium is increased by such a signature since at the destination there must not be a risk that damage to data systems there or errors (for example by the software for readout of the data or for processing of the data) can occur.

An authentication can ensue dependent on assumptions about validation methods at a destination of the personal electronic data and/or about the availability of a public key of an author of the personal electronic data. So that an authentication is securely practical, it is advantageous when it is known which validation methods exist at a destination. Different signatures for a file or for multiple identically-stored files, which different signatures can be checked with different validation methods, can possibly be stored on a data medium. Furthermore, a public key of a data creator can be required to make an authentication possible, which public key is correspondingly provided (for example on the data medium or via a link on the data medium) or is accessible via a third party. A distribution of a crucial validation method or important public keys can possibly ensue in advance, which public keys are also provided at a known location (for example on a server on the Internet) for general or limited retrieval. Via the authentication mechanisms, the problem does not occur of the data or a software possibly not being used only because the validity cannot be checked due to an unavailable validation method.

According to the invention, a reference and/or localization information for a server (in particular a uniform resource locator) can be used as at least one means to enable the presentation and/or the access to at least one part of the personal electronic data. For example, in this case a complete program packet is not stored on the data medium or there exists on the medium only a portion of the software that is required for reading or processing the data. Instead of the complete software a reference is stored on the data medium, or such a reference is stored on the medium upon generation of the data information that, for example, indicates where the necessary software or a further means for presenting or for access to the data can be obtained. The reference advantageously enables the software or such a information to be obtained without additional costs. The basic costs can possibly be satisfied through a subscription or a possible obligatory membership of physicians in a corresponding service organization.

At least one mechanism to present and/or to access at least one part of the personal electronic data, in particular a program, can be downloaded from a server and/or can be executed externally on this server. For example, the data medium thus merely contains a uniform resource locator (URL) that represents localization information for the software or other information for presenting or accessing the data.

Furthermore, in the inventive method a mechanism can be provided that enables both the presentation and/or the access to at least one part of the personal electronic data and at least one means for presenting and/or accessing at least one part of the electronic data can be stored on the data medium, in particular such that a (possibly less comprehensive) program means is provided on the data medium and a (possibly more comprehensive) additional program means is provided via a server. In this case both elements are thus used in combination. Software with basic capabilities is provided (for example as a more comprehensive software) via a server and can be located via a reference on the medium while the adaptation or extension of this software which is specialized with regard to the respective data stored on the data medium and is possibly smaller is immediately present on the medium. The required memory capacity for the software or the display and presentation mechanism on the medium is thereby reduced. The number of the versions in which centrally stored software must be kept is reduced.

Moreover, a payment function can be used in the framework of the transfer and/or the provision of the personal electronic data for at least one mechanism for presentation and/or for accessing and/or to enable the presentation and/or access to at least one part of the personal electronic data on the data medium. In this case a payment function for the patient or for a superordinate organization entrusted with the payment is thus integrated into the inventive method. The payment can contain the development, the administration and/or the use of an electronic health software according to the implemented architecture variant. The payment function can be fashioned such that a payment is provided either for each individual patient or for a specific procedure or a usage. For example, a data network-supported payment process can be initiated via the software for this purpose.

Moreover, the invention concerns a data medium for personal electronic data of an owner, in particular for health-related electronic data of a patient, in particular for implementation of a method as described in the preceding, wherein the data medium is fashioned such that the personal electronic data are stored on this data medium at least partially encrypted together with at least one decryptor for at least partial decryption as well as at least one mechanism for presenting and/or for accessing and/or for enabling the presentation and/or the access to at least one part of the electronic data.

Such a data medium clearly differs from active “health cards” in development on which medical data are in fact stored but without software, thus without an ability for accessing or for presenting. Such active “health cards” serve primarily for identification of the owner and moreover for storage of his private keys which are provided separately (for example on a separate medium) for security reasons, in contrast to the situation the inventive data medium or, respectively, method.

Furthermore, the inventive data medium has the advantage exists that, in contrast to the active “health cards”, it requires no active processor elements since it does not have to be used as an execution location for the decryption or the signature check. Rather, the data medium is advantageously a passive memory, and thus it is enabled to store larger data sets. At the same time the inventive data medium in its fundamental embodiment can be produced in a comparably advantageous manner.

Moreover, the invention concerns a facility for transferring and/or providing personal electronic data of an owner, in particular health-related electronic data of a patient, in particular for implementation of a method as described in the preceding, wherein the facility has at least one data medium (in particular as already described) that is fashioned such that the personal electronic data are stored thereon at least partially encrypted together with at least one decryptor for at least partial decryption as well as at least one mechanism for presentation and/or access and/or to enable the presentation and/or the access to at least one part of the electronic data.

A secure relaying of comprehensive data sets in specialized formats is thus enabled by the inventive facility.

The facility possibly can have at least one further data medium for at least one further decryptor element (in particular a key) and/or at least one server accessible over a data network on which is stored at least one mechanism to present and/or to access at least one part of the personal electronic data.

The facility for transferring or providing the patient data thus advantageously has a passive data medium on which are stored the patient data, the decryption elements and suitable software to present or process the data. Moreover, for example, a further key that is present on a separate storage medium of the facility (for example a computer or a CD or a DVD or the like) can be required for a final decryption. Furthermore, the facility can have at least one server which can be accessed in order to obtain further decryption elements such as a one-time key for a physician. Furthermore, software for the presentation of and/or access to the data or another suitable means can be present on the server. This software thus can be downloaded or executed as described in the preceding with regard to the inventive method.

Furthermore, the facility can have at least one apparatus fashioned to present and/or to access the data stored on the at least one data medium and/or for storage of personal electronic data on the at least one data medium. For example, a computer can be present into the drive of which the data medium is inserted in order to read out or, respectively, to modify the data. Furthermore, newly produced personal electronic data or personal electronic data to be modified can be stored, for example, on the data medium with the aid of such a computer or a card reader or access device of other design.

Moreover, the facility advantageously has a module that is fashioned to process signature information, in particular in the framework of an authentication as described in the preceding. This apparatus can likewise be an apparatus with a generally or specifically fashioned computation capacity. Such a device fashioned for processing of signature information can possibly be the same computer that is also provided for the presentation of or for the access to the personal electronic data. For this purpose, the computer is possibly equipped with a correspondingly comprehensive software or respective special programs.

### BRIEF DESCRIPTION OF THE DRAWINGS

FIG. 1 is a block diagram illustrating implementation of a basic embodiment of the inventive method.

FIG. 2 is a block diagram illustrating implementation of an inventive method with access to a server for downloading a program.

FIG. 3 is a block diagram illustrating implementation of the method with access to a server for external execution of a program means.

FIG. 4 is a block diagram of an inventive facility.

### DESCRIPTION OF THE PREFERRED EMBODIMENTS

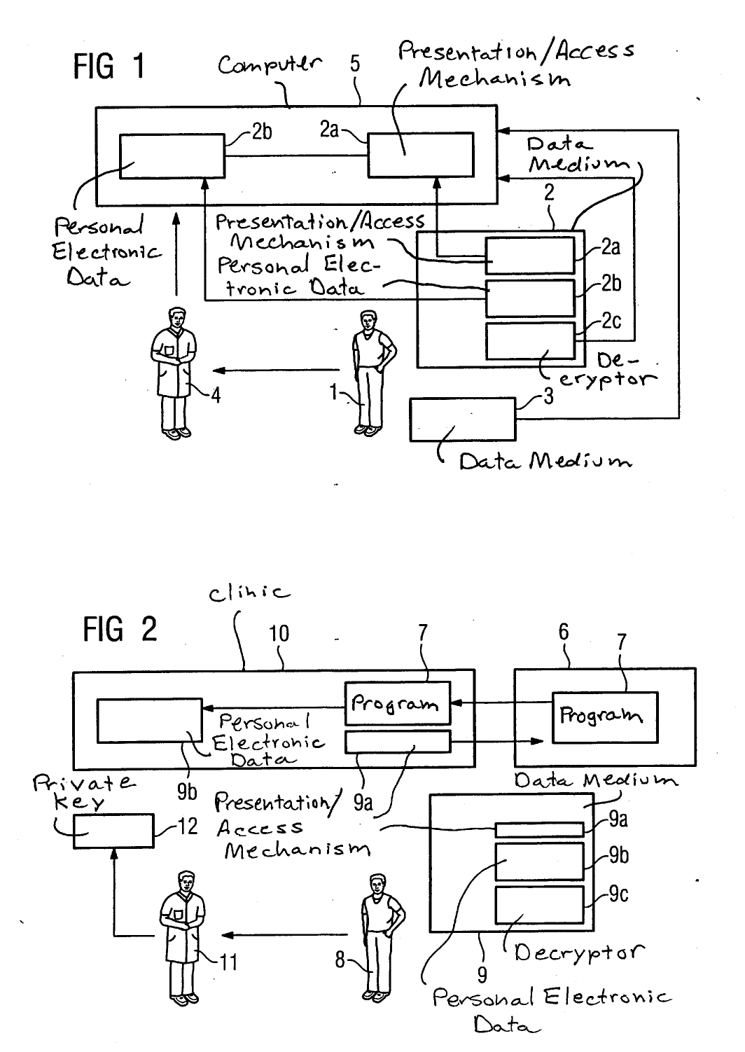

A basic representation for implementation of an inventive method to transfer or provide personal electronic data of an owner is shown in FIG. 1. In the present case the owner is a patient 1 to whom is provided: a passive data medium 2 that includes a mechanism 2a for presentation of or for access to personal electronic data; the actual personal electronic data 2b, and a decryptor 2c for partial decryption of the personal electronic data. These items 2a and 2c and the data 2b are stored on the data medium 2 for transfer.

Furthermore, the patient 1 has an additional data medium 3 on which is stored the patient's private key.

The patient 1 with the data medium 2 as well as the additional data medium 3 now repairs to a health professional 4 (who is presently a general practitioner 4). The health professional 4 possesses a computer 5 or an associated information technology system that is fashioned to access the data medium 2 as well as the further data medium 3. These access possibilities are indicated by arrows in the representation.

The computer 5 of the health professional 4 extracts the personal electronic data 2b as well as the mechanism 2a for presentation of or for access to the data 2b. The personal electronic data 2a are normally stored on the data medium 2 such that the production of a local copy on the computer 5 is not possible, but this can be allowed (possibly after a release by the patient 1). With the mechanism 2a for presentation of or for access to the at least one part of the personal electronic data 2b, it is possible for the health professional to read and possibly also to process (for example to supplement or to overwrite) the data after a decryption with the mechanism 2c and the data medium 3. This possibility is indicated by the connection between the mechanism 2a and the personal electronic data 2b in the computer 5. The mechanism 2a for presenting or accessing at least one part of the data can be executed from the data medium as a program. If applicable, in the framework of the method it is also possible (as is the case here) to download the mechanism 2a from the data medium 2 and to install it locally on the computer 5 of the health professional 4.

A data transfer or provision of sensitive health data of a patient 1 is thus enabled with the inventive method without special assumptions having to be made about software at the destination of the data 2b (thus here in the practice of a health professional 4). At the same time the data 2a are available in a secured manner for at least partial decryption in connection with the further data medium 3 with the private key of the patient 1, such that the high requirements for reliability are ensured while also for limiting access to the personal electronic data 2b.

FIG. 2 shows a basic representation for implementation of then inventive method with access to a server 6 for downloading of a program 7. In this case the transfer of the data 9b is in turn achieved with the help of the patient 8, who carries a data medium 9 with personal electronic data 9b, a decryptor for at least partial decryption that is designated with the reference character 9c, and a reference 9a as a means to enable the presentation of or the access to the personal electronic data 9b.

The reference 9a points to the server 6 on which the program means 7 is stored for download.

For treatment the patient 8 goes to a clinic 10 in which the health professional 11 works. The patient 8 carries the data medium 9.

A connection to the server 6 from which the program means 7 is downloaded is established in the clinic 10 using the reference 9a via a corresponding computer (not shown in detail). The program 7 is therefore available in the clinic 10. With the program 7, an information technology system at the clinic 10 can prepare the personal electronic data 9b for an access or a presentation after decryption with the use of the decryptor 9c.

The decryptor 9c for at least partial decryption of the personal electronic data 9b is securely stored on the data medium 9. In order to enable a final decryption in the inventive method, the private key 12 of the health professional 11 or of the clinic 10 is required.

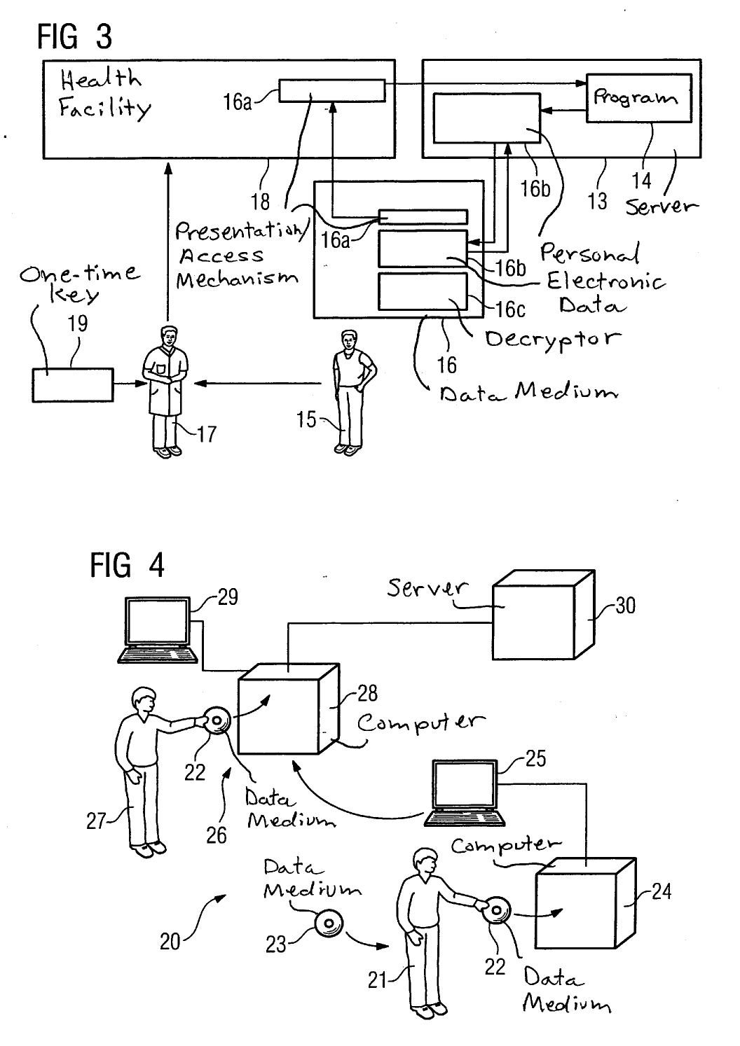

FIG. 3 shows a basic representation for implementation of an inventive method with access to a server 13 for external execution of a program 14. The patient 15 carries a data medium 16 on which are stored the personal electronic data 16b, a decryptor 16c for at least partial decryption as well as a reference 16a for a software (here the program 14).

The patient brings the data medium 16 to a health professional 17 who is associated with a health facility 18 in which the reference 16a is accessed via a corresponding reader for the data medium 16. This occurs dependent on a one-time key 19 which has been sent by a secure party to the health professional 17 after the generation of the data medium 16.

An access to the personal electronic data 16b is possible with the aid of the reference 16a and the decryptor 16c and the one-time key 19. This occurs such that the personal electronic data 16b are transferred for access to the server 13 at which the program 14 is executed externally (“remotely”) in order to enable a reading and processing of the data. the processed data can in turn be stored on the data medium 16. The connection to the server 13 is a secure data connection.

FIG. 4 shows an inventive facility 20 to transfer or to provide personal electronic data of an owner. The owner 21 has a data medium 22 on which are stored decryption mechanisms, means for data presentation of or, respectively, for accessing the data and the data themselves in at least partially encrypted form.

The private key of the owner 21 is located on a further data medium 23.

For readout the data medium 22 is inserted into a reader of the computer 24 that is connected with a screen 25 in order to enable a viewing or, respectively, processing of the personal electronic data of the data medium 23. In order to be able to completely decrypt the encrypted stored data, in addition to the decryption mechanisms on the data medium 22 the private key on the data medium 23 is required, whereupon this is likewise provided to the computer 24 for access.

In the case shown here, the owner 21 can thus access his data without limitation. Realizations are also possible in which the private key on the data medium 23 of the owner 21 enables only a readout of a portion of the data or, respectively, a processing in a limited scope.

To transfer the data the owner 21 with the data medium 22 and possibly with the data medium 23 repairs to a destination 26 at which the data owner hands over the data medium 22 to a further person 27 who provides this (possibly under observation by the owner 21) to a computer 28 at the destination. The computer 28 is coupled with a monitor 29 for display of or access to the personal electronic data of the data medium 22.

A connection exists from the destination 26 to a server 30 from which a more comprehensive software for examination or processing of the data of the data medium 22 is downloaded. More specialized, smaller software is located directly on the data medium 22. Moreover, the owner 23 provides his or her private key on the data medium 23 to the further person 27 to enable the complete decryption with the aid of the decryption mechanisms of the data medium 22. This is not shown here. Alternatively, the further person 27 can be authorized to obtain a one-time key from a third party or the like.

Overall, relaying of even extensive data sets (for example extensive image series from medical acquisitions) is enabled with the inventive facility, and no assumptions must be made about already-present software at the destination. Through the encrypted storage of the data it is possible with the inventive facility to transfer the data securely and with protection of the privacy of the owner 21, and possibly in an authenticable manner by use of a signature.

Although modifications and changes may be suggested by those skilled in the art, it is the intention of the inventor to embody within the patent warranted hereon all changes and modifications as reasonably and properly come within the scope of his contribution to the art.

1. A method for transferring and/or providing personal electronic data of a data owner, comprising the steps of:
storing personal electronic data of a data owner on a portable storage medium at least partially encrypted;
also storing on said data medium a decryptor that participates in decryption of the encrypted data stored on the data medium; and
also storing on the data medium a mechanism that allows at least one of presentation of and access to the personal electronic data stored on the data medium.

2. A method as claimed in claim 1 comprising storing a program on said data medium as said mechanism for at least one of presentation of and access to said personal electronic data.

3. A method as claimed in claim 1 comprising storing said decryptor in an access-protected form on said data medium.

4. A method as claimed in claim 1 comprising storing said personal electronic data on said data medium in a specialized format.

5. A method as claimed in claim 1 comprising employing a passive data medium as said medium.

6. A method as claimed in claim 1 wherein said mechanism for at least one of presentation of and access to said personal electronic data is a mechanism selected from the group consisting of a mechanism enabling presentation of said personal electronic data to the owner, a mechanism allowing presentation of the data to a health professional, and a mechanism allowing access to the personal electronic data by a data-reading apparatus.

7. A method as claimed in claim 1 comprising forming said data medium as a medium available to said data owner.

8. A method as claimed in claim 1 comprising, for decrypting said encrypted data requiring use of information that is not stored on said data medium, in addition to said decryptor.

9. A method as claimed in claim 8 comprising forming said information as a secret key that is exclusively available to the data owner or at least one private key that is maintained on a further data medium before generation of the data medium, or a one-time key provided to a representative of the data owner by a third party.

10. A method as claimed in claim 9 comprising decrypting said encrypted personal electronic data locally at a location of the data medium with the use of said at least one secret key or said private key or by accessing a datum network to obtain said one-time key.

11. A method as claimed in claim 1 comprising requiring authentication of said personal electronic data stored on said medium by at least one signature to verify integrity of said personal electronic data upon presentation of or access to said personal electronic data.

12. A method as claimed in claim 1 comprising requiring authentication of said mechanism for at least one of presentation or access to said personal electronic data by a signature.

13. A method as claimed in claim 12 comprising authenticating said personal electronic data using a validation technique at a destination of the personal electronic data or using a public key of an author of the personal electronic data.

14. A method as claimed in claim 1 comprising requiring registration or localization information for a server to enable at least one of presentation of or access to at least a portion of said personal electronic data.

15. A method as claimed in claim 14 comprising downloading said mechanism for at least one of presentation of or access to said personal electronic data from a server, and executing said mechanism using said server.

16. A method as claimed in claim 1 wherein said mechanism is a first mechanism, and comprising storing a second mechanism on said storage medium for at least one of presentation of and access to said personal electronic data, and requiring operation of both of said first and second mechanisms to present or access said personal electronic data.

17. A method as claimed in claim 1 comprising automatically implementing a payment function upon execution of said mechanism for at least one of presentation of and access to said personal electronic data.

18. A data carrier for transferring and/or providing personal electronic data of a data owner, comprising:
a portable storage medium configured to be carried by an owner of personal electronic data;
a first storage location on said portable storage medium at which said personal electronic data of the data owner are stored at least partially encrypted;
a second storage location on said data medium at which a decryptor is stored that participates in decryption of the encrypted data stored on the data medium; and
a third storage location on the data medium at which a mechanism is stored that allows at least one of presentation of and access to the personal electronic data stored on the data medium.

19. A facility for transferring and/or providing personal electronic data of a data owner, comprising:
a data carrier comprising a portable storage medium configured to be carried by an owner of personal electronic data, a first storage location on said portable storage medium at which said personal electronic data of the data owner are stored at least partially encrypted, a second storage location on said data medium at which a decryptor is stored that participates in decryption of the encrypted data stored on the data medium, and a third storage location on the data medium at which a mechanism is stored that allows at least one of presentation of and access to the personal electronic data stored on the data medium; and
at least one computer configured to interact with said personal electronic data via said personal storage medium.

20. A facility as claimed in claim 19 comprising at least one further data medium on which are stored at least one further decryptor, and said facility comprising a server accessible via a data network at which a further mechanism for at least one presentation of and access to said personal electronic data, or for decryption of said personal electronic data.

21. A facility as claimed in claim 19 comprising at least one apparatus to present or access said personal electronic data stored on said data medium and to store the presented or accessed personal electronic data.

22. A facility as claimed in claim 19 comprising at least one processor for processing a signature for authentication of said personal electronic data stored on said medium.
